(19) United States
(12) Patent Application Publication
(10) Pub. No.: US 2018/0132460 A1
(43) Pub. Date: May 17, 2018

(54) Retrieval Float

(71) Applicant: Toothless, Inc., Dunedin, FL (US)

(72) Inventor: Michael Rega, Dunedin, FL (US)

(21) Appl. No.: 15/798,797

(22) Filed: Oct. 31, 2017

Related U.S. Application Data
(63) Continuation of application No. 62/420,595, filed on Nov. 11, 2016.

(51) Int. Cl. A01K 81/06; B63B 22/00; A01K 97/12

(52) U.S. Cl. CPC A01K 81/06; A01K 97/12; B63B 22/00

(57) ABSTRACT

The disclosed device is a retrieval float for use during spear fishing and diving. The retrieval float allows a diver to send marine organisms that have been caught by various underwater methods to the surface. By eliminating the practice of securing catches to oneself for the duration of the dive, the retrieval float decreases the chances of dangerous encounters with underwater predators that are attracted to blood. A fish, lobster, abalone, or other marine organism is secured to the retrieval float and returned to the surface for a spotter boat to collect.

### CROSS-REFERENCE TO RELATED APPLICATION

This application is a continuation of U.S. provisional application Ser. No. 62/420,595, filed Nov. 11, 2016.

### FIELD

This invention relates to the field of fishing and diving and more particularly to a system that allows a diver to float fish, lobster, and other marine organisms caught by various methods to the surface.

### BACKGROUND

When diving or spear fishing, a diver typically attaches caught fish, lobster, abalone, or other marine organisms to herself until she returns to the surface. As one might expect, attaching bloody fish to oneself while diving can lead to unwanted encounters with marine predators that are attracted by the smell of blood.

What is needed is a way to minimize the risk of dangerous encounters while catching marine prey by various underwater catching methods.

### SUMMARY

The solution is a device that floats catches to the surface for retrieval by a boat or vessel. The disclosed device, or retrieval float, is a series of flotation devices that are held to the diver. While underwater, the diver attaches caught fish, lobster, abalone, or other marine organisms to a float that is subsequently inflated. After inflation the diver releases the float, the float then rising to the surface for pickup by a spotter boat.

In addition to retrieval, the retrieval float signals to the boat the location of the diver. In situations with multiple divers, the retrieval floats are individually labeled with each diver's name. This allows the boat to track the specific catch by each diver as well as the location of each diver.

The retrieval float has following components: a plurality of standard floats and a soft stringer to which the standard floats attach.

Each standard float is further comprised of a spike, a spike line, a bladder, an inflation valve, an air release valve, and a retrieval strap.

In additional embodiments, the spike may be replaced with a hook, a clasp, a clip, a noose, or a net. The type of securing means is determined based on the type of marine organism being attached.

For ease of discussion, the following explanation will be directed to a float having a spike and sending a caught fish to the surface. The standard floats are used in the following manner:

The fish is secured to the standard float by inserting a spike through the eyes of the fish. The spike is a rod with a pointed tip for insertion through a fish. The spike is attached to the float via a spike line. The spike line is a cord or line that connects the spike and float.

The standard float has a bladder to hold air, thereby rendering the standard float buoyant. The inflation valve is configured to keep water out but allow air to pass into the bladder when mated with the air hose. When the diver has on full scuba gear, the bladder is filled with air from a diver's tank via an inflation valve. But during a free dive, the bladder may be inflated by mouth or using a carbon dioxide cartridge.

As the float ascends to the surface, the external water pressure gradually decreases. The air release valve exhausts air from the bladder during ascension to prevent failure of the float due to over-pressurization and subsequent expansion.

Each float includes a retrieval strap. The retrieval strap is a loop used for retrieval of the float. At the water's surface the retrieval strap is either grabbed by hand, or hooked, to bring the float and catch to the boat.

Now turning to a discussion of the soft stringer. The soft stringer is a support structure that attaches to the diver, holding the floats during a dive. The soft stringer includes the following parts: a frame, one or more removable fasteners, an attachment clip, a final spike, and a spike line.

The frame is the portion of soft stringer to which all items attach. The standard floats attach to the soft stringer via removable fasteners. In one embodiment the final float is permanently affixed to the soft stringer. In alternative embodiments the final float is removable for replacement in the event of damage.

The final spike is attached to the soft stringer by a spike line, rather than being attached to the bladder of the final float.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a retrieval float kit.

FIG. 2 illustrates a front view of float storage assembly with five standard floats and one final float, the side shown including two standard floats and the final float.

FIG. 3 illustrates a side view of float storage assembly showing the five standard floats and the final float.

FIG. 4 illustrates a rear view of float storage assembly showing the side with three standard floats.

FIG. 5 illustrates a view of the float storage assembly with the standard floats removed from the soft stringer, depicting the final float affixed to the soft stringer.

FIG. 6 illustrates a standard float open and ready for use with a fish.

FIG. 7 illustrates the final float open and ready for use with multiple fish.

FIG. 8 illustrates the float storage assembly is connected to a diver by the attachment clip and the inflation hose ready to inflate a float.

FIG. 9 illustrates the diver inflating a standard float by engaging the inflation hose with the inflation valve.

FIG. 10 illustrates a close-up view of the diver prepared to inflate a standard float using the inflation end of the inflation hose and the speed inflate valve.

FIG. 11 illustrates a close-up view of the inflation end depressing the tip of the inflation valve, thus allowing air to pass from the diver's tank through the inflation hose to the bladder.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

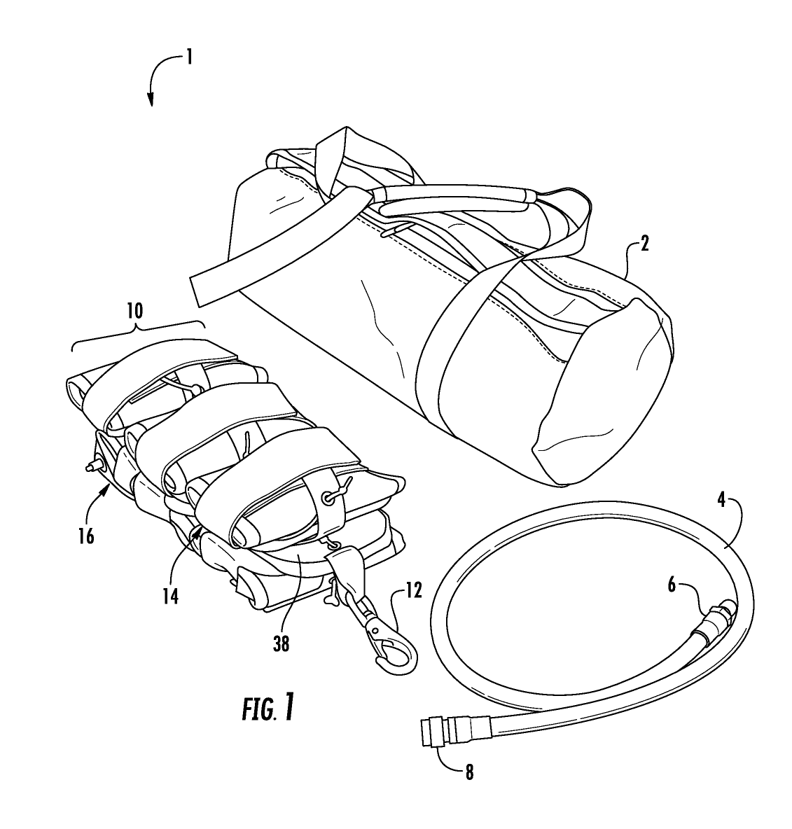

Referring now to FIG. 1, a kit containing all materials for the retrieval float is shown. The retrieval float kit 1 comprises a bag 2, an inflation hose 4, and a float storage assembly 10. The float storage assembly 10 is comprised of five standard floats 14 that are removably attach to the soft stringer 38. A final float 16 is affixed to one end of the soft stringer 38.

In some embodiments, the standard floats 14 and final float 16 may be different colors so that the retrieval boat will know when the diver sends up the final float 16.

There is an attachment clip 12 on the soft stringer 38 on the end opposite the final float 16. The attachment clip 12 secures the float storage assembly 10 to a diver.

The air hose 4 has two ends: the regulator attachment 6 and the inflation end 8. The regulator attachment 6 connects to the first stage of a diver's regulator. The inflation end 8 mates with the inflation valve 28 (not shown) to inflate a bladder 29.

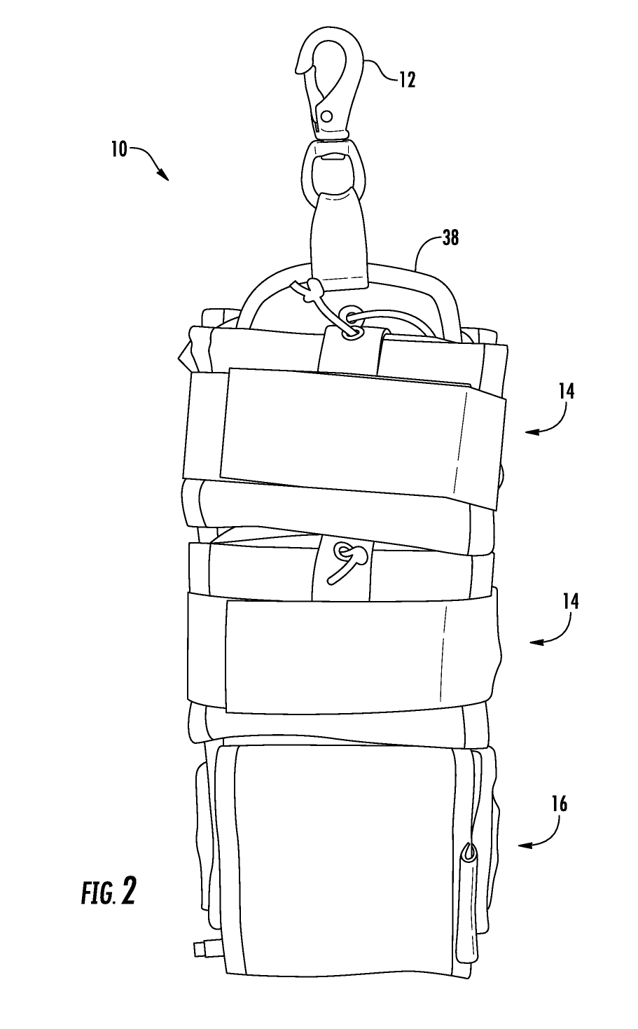

Referring now to FIG. 2, a front view of the float storage assembly 10 is shown. On this side of the float storage assembly 10, two standard floats 14 and the final float 16 are shown attached to the soft stringer 38.

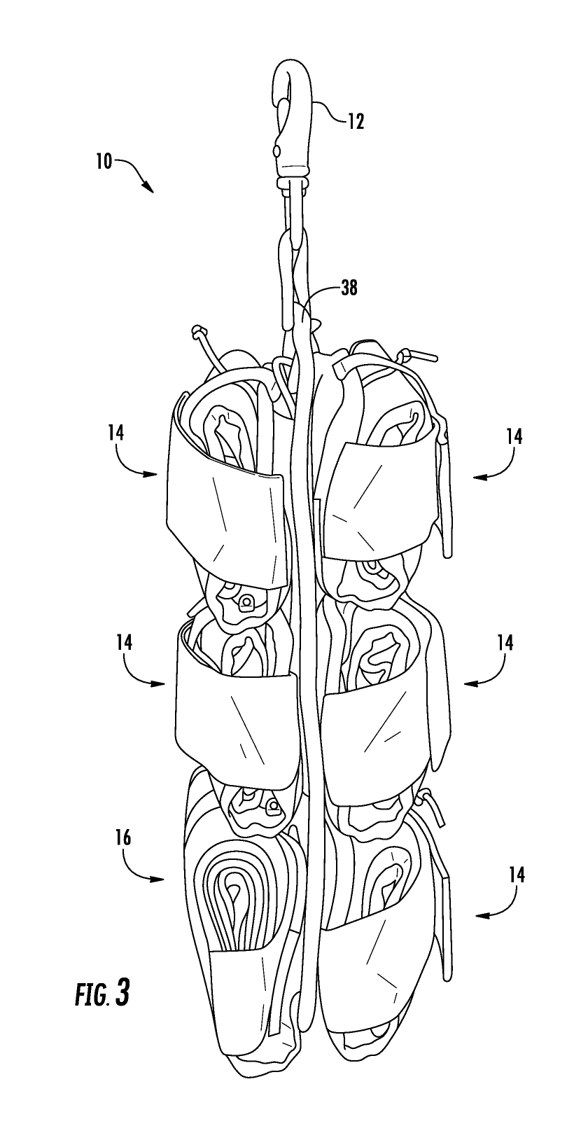

Referring now to FIG. 3, a side view of the float storage assembly 10 is shown. The side view provides a better understanding of the orientation of the six floats 14/16 when all six are attached to the soft stringer 38, resulting in a full float storage assembly 10.

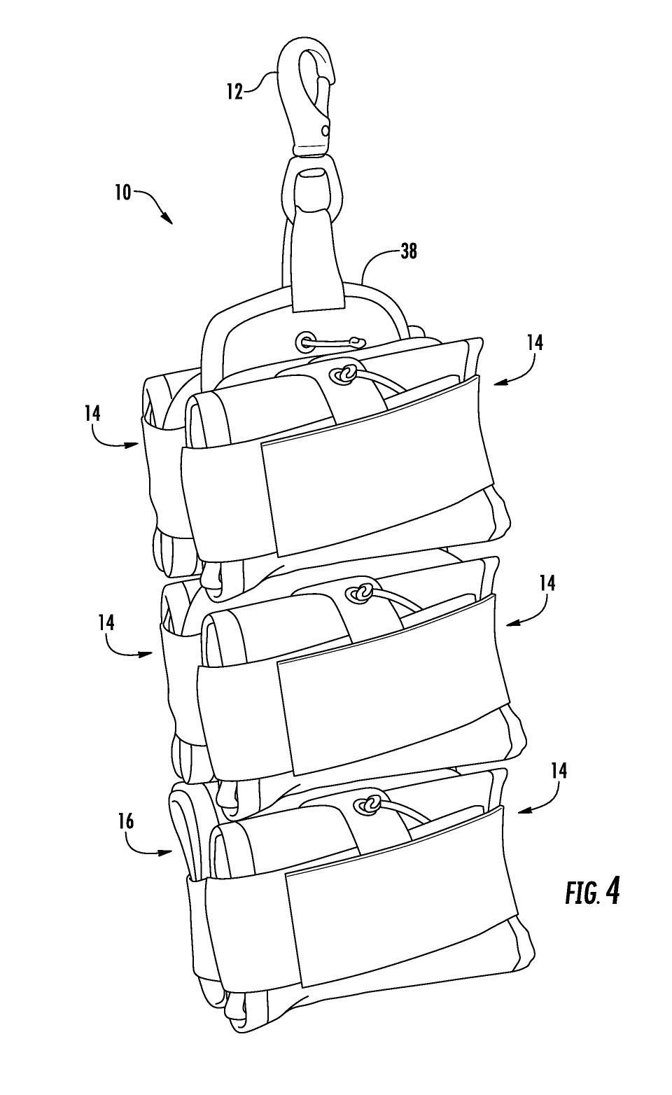

Referring now to FIG. 4, a rear view of the float storage assembly 10 is shown. This side of the float storage assembly 10 shows three standard floats 14 attached to the soft stringer 38.

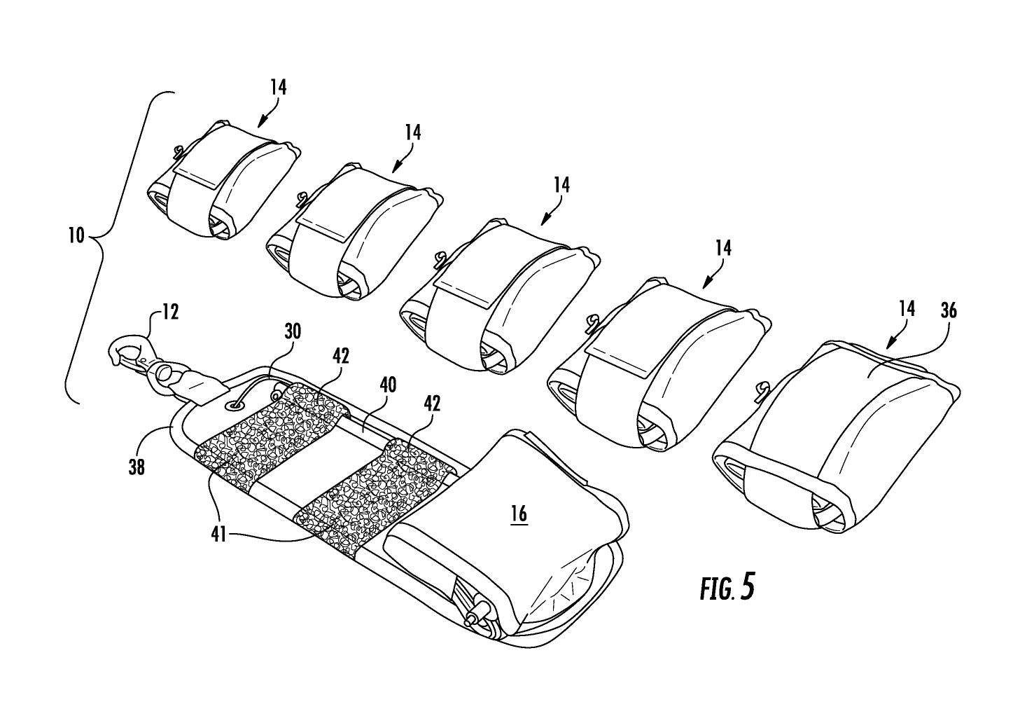

Referring now to FIG. 5, a view of the float storage assembly 10 is shown. The five standard floats 14 are shown removed from the soft stringer 38. With the standard floats removed, the removable fasteners 41 are shown. The final float 16 remains affixed to the soft stringer 38.

The final spike 40 is held under the removable fasteners 41 by the final spike channels 42. The final spike 40 attaches to the soft stringer 38 via a spike line 30. The spike line 30 is attached to the soft stringer 38 near the upper end of the soft stringer 38, adjacent to the attachment clip 12.

Also shown is the safety tape 36 on the back of a standard float 14.

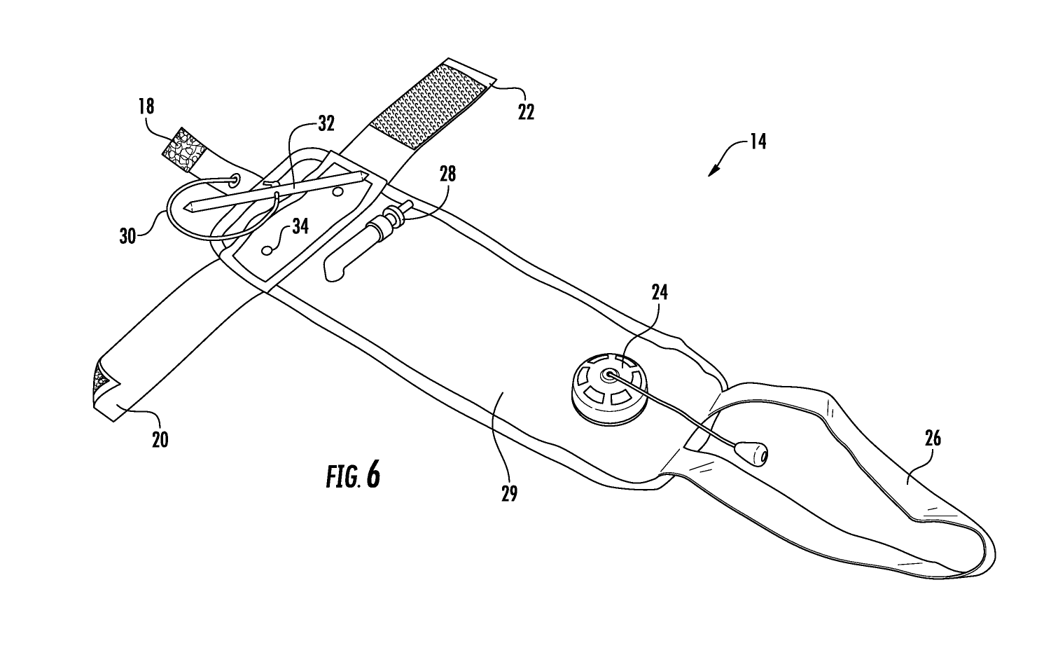

Referring now to FIG. 6, a standard float 14 is shown removed from the float storage assembly 10 and opened. The standard float 14 includes: the a-strap 18, b-strap 20, c-strap 22, air release valve 24, retrieval strap 26, inflation valve 28, bladder 29, spike line 30, spike 32, spike trap 34, and safety tape 36 (see FIG. 5).

Each standard float 14 is stored in its rolled position before being secured to the float storage assembly 10. The floats 14/16 are rolled up from the retrieval strap 26 end to the spike trap 34 end. Once rolled up, the b-strap 20 is folded over, then the a-strap 18 is folded across the b-strap 20, then the c-strap 22 is folded across the a-strap 18 and fastened to the b-strap 20.

Now turning to a discussion of using the retrieval float 1. When a fish is ready to be sent to the surface, one standard float 14 is removed from the float storage assembly 10. Next, the standard float 14 is unrolled and the spike 32 is extracted from the spike trap 34. The spike 32 is pushed through the eyes of a fish, or other area of the fish suitable for securing via puncture. With the entire spike 32 through the fish, the fish is secured on the spike line 30 with the spike 32 being perpendicular to prevent the fish from sliding off the spike line 30.

Next, the inflation end 8 is mated with the inflation hose 4 using the inflation valve 28. The bladder 29 is filled with air from the regulator in a matter of seconds.

Once the bladder 29 is inflated, the standard float 14 is carried to the surface by its buoyancy.

As the standard float 14 rises, the external pressure decreases. To prevent over-expansion or explosion of the bladder 29, the air release valve 24 burps air out of the bladder 29 as the external pressure decreases.

When the standard float 14 surfaces, the bright color and reflective safety tape 36 make it easily visible for a vessel find. The fish and the standard float 14 is scooped, hooked, or grabbed out of the water using the retrieval strap 26.

In some embodiments, the safety tape 36 may even have the name of a diver written on it. This feature is most useful when multiple divers are out at the same time.

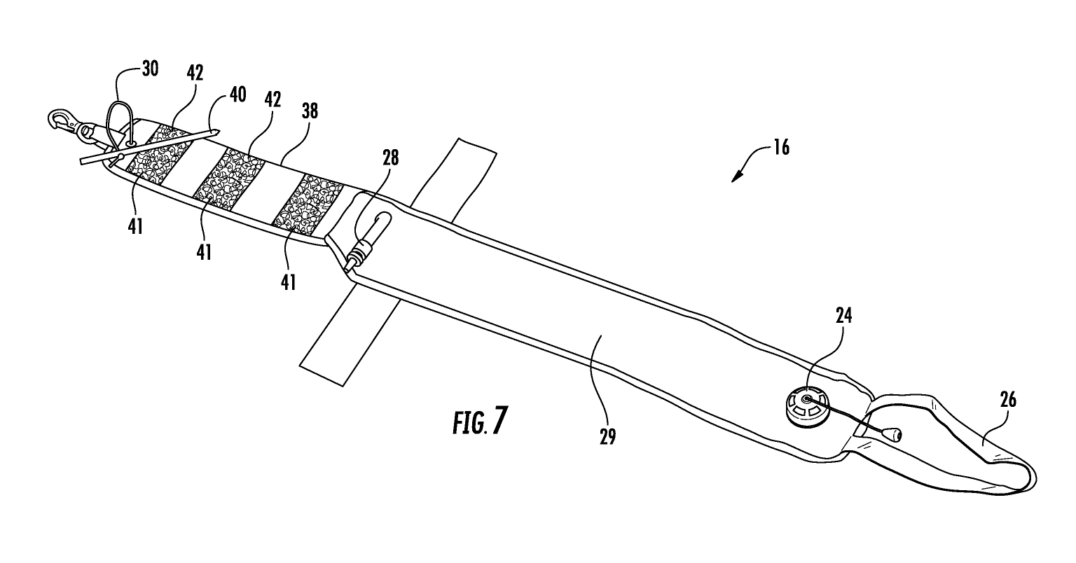

Referring now to FIG. 7, the final float 16 is shown. The final float 16 is longer than the standard floats 14. The purpose of a longer float is the ability to load multiple fish onto the final float 16. This feature is helpful when a diver has a particularly successful day of spear fishing. For example, if the diver is on her final float 16, she has already successfully sent five fish to the surface. But if she comes across another school and successfully spears two or more fish, a larger buoyancy force will be required to raise that load to the surface. The increased buoyancy is created by a longer final float 16 that has a larger bladder 29.

Another difference is the final spike 40 is attached to the spike line 30 at a three-quarter point instead of in the center like the standard spikes 32. The three-quarter attached final spike 40 makes it easier to push the spike through multiple fish.

Another benefit of the final float 16 being longer is that the vessel will know that the diver has completed her dive and will be surfacing soon and near the position of the final float 16.

In some embodiments, the final float 16 is a different color.

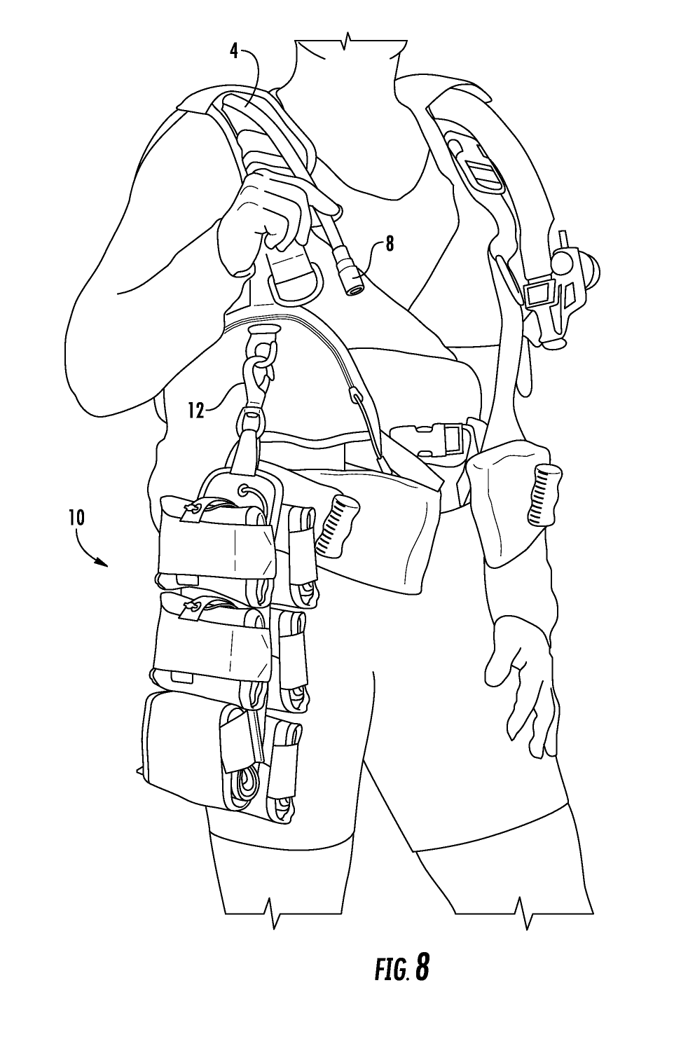

Referring now to FIG. 8, a diver is shown with the retrieval float kit 1 attached to her dive gear via the attachment clip 12. The inflation hose 4 is connected to her regulator and secured through her shoulder strap in an easily accessible location to apply the inflation end 8 to the inflation valve 28.

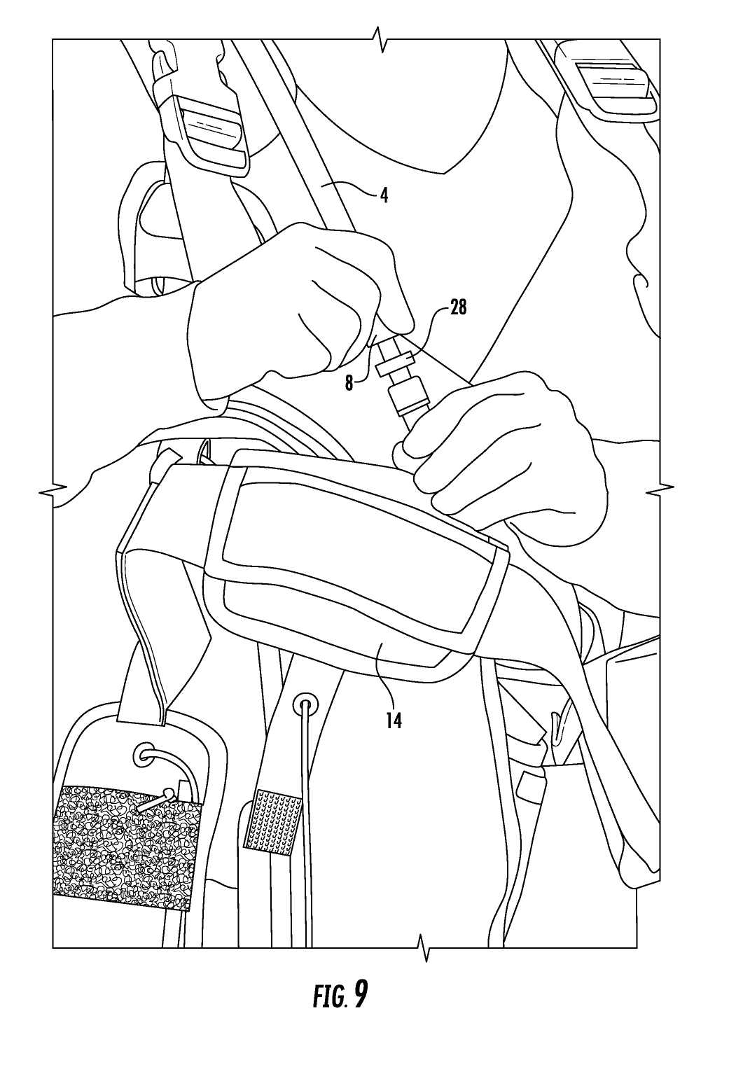

Referring now to FIG. 9, the diver has removed a standard float 14 and is mating the inflation end 8 of the inflation hose 4 to the inflation valve 28.

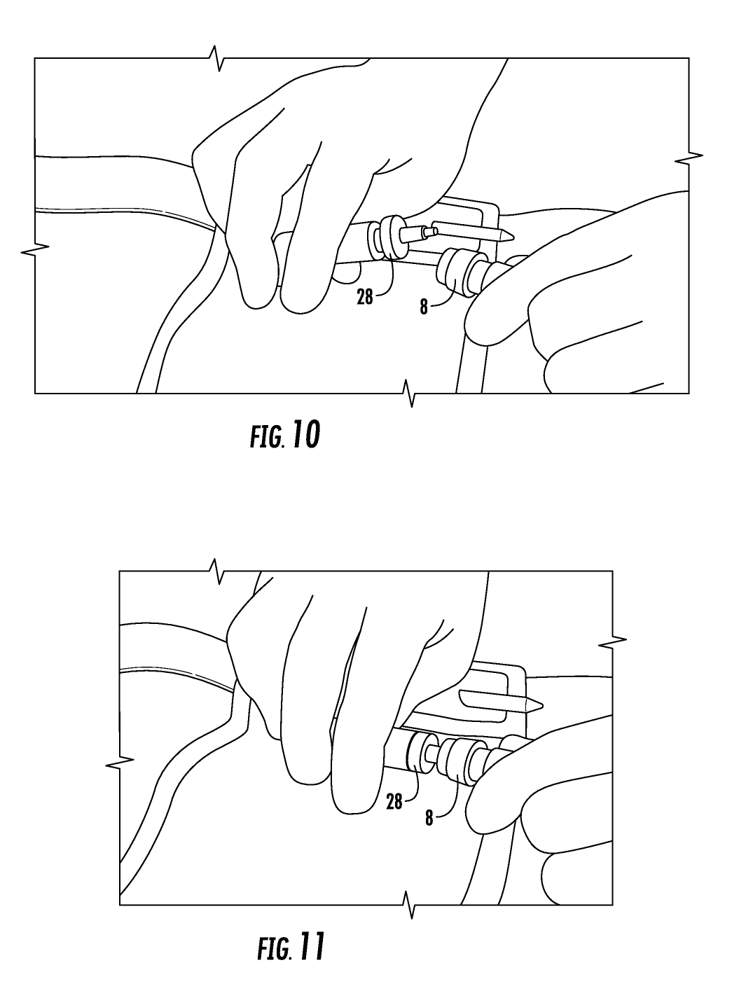

Referring now to FIGS. 10 and 11. FIGS. 10 and 11 illustrate a feature of the inflation valve 28 that prevents water from entering the bladder 29 but allows air to enter the bladder 29 when mated with the inflation hose 4. That feature is a depressible tip. When the tip is in the normal state, the tip is raised by an internal spring mechanism. In the normal state, no air or water may pass through the inflation valve 28. When mated with the inflation end 8 of the inflation hose 4, the inflation end 8 depresses the tip of the inflation valve 28. When depressed, air may pass into the bladder 29.

In FIG. 10, a close-up view of the diver about to engage the inflation end 8 with the inflation valve 28 is shown. The tip of the inflation valve 28 is shown in the normal state.

Referring now to FIG. 11, shows a close-up view of the inflation valve 28 receiving air from the inflation hose 4. The tip of the inflation valve 28 is shown being depressed.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A specimen retrieval apparatus, the specimen retrieval apparatus comprising:
one or more inflatable floats, each of the one or more inflatable floats including a spike connected by a spike line to one of the one or more inflatable floats; and
whereby a diver affixes a specimen to the spike before inflating one of the one or more inflatable floats to raise the specimen to the surface.

2. The specimen retrieval apparatus of claim 1, each of the one or more inflatable floats further comprising an over-inflation valve, the over-inflation valve configured to expel air from a respective one of the one or more inflatable floats during ascension to the surface.

3. The specimen retrieval apparatus of claim 1, each of the one or more inflatable floats further comprising:
a storage member, the storage member removably affixed to the diver; and
wherein the one or more inflatable floats are removably affixed to the storage member.

4. The specimen retrieval apparatus of claim 1, further comprising an inflation valve located on each of the one or more inflatable floats, the inflation valve configured to prevent water from entering the one or more inflatable floats while under water.

5. The specimen retrieval apparatus of claim 1, wherein the one or more inflatable floats vary in size.

6. The specimen retrieval apparatus of claim 1, wherein the one or more inflatable floats include a reflective portion.

7. A specimen retrieval device for use while diving, the specimen retrieval device comprising:
one or more floats, each of the one or more floats having an air bladder; and
whereby a diver attaches one of the one or more floats to a specimen and inflates the air bladder to send the specimen to a water's surface for retrieval.

8. The specimen retrieval device of claim 7, wherein each of the one or more floats further comprises:
a spike, and
a spike line, the spike line connecting the spike to one float of the one or more floats; and
whereby the spike punctures the specimen to secure it to one float of the one or more floats for ascension to the surface.

9. The specimen retrieval device of claim 7, wherein each air bladder of one float of the one or more floats includes an over-inflation valve, the over-inflation valve configured to expel air out of each air bladder of the one or more floats as the specimen retrieval device rises, thereby compensating for decreased pressure.

10. The specimen retrieval device of claim 7, wherein each air bladder of one float of the one or more floats includes an inflation valve, the inflation valve configured to inflate each air bladder of one float of the one or more floats under water.

11. The specimen retrieval device of claim 7, wherein the one or more floats are removably attached to the diver.

12. The specimen retrieval device of claim 7, wherein the one or more floats are of two or more sizes.

13. The specimen retrieval device of claim 7, wherein the one or more floats include a reflective portion.

14. A device for retrieval of fish during underwater spear fishing, the device comprising:
one or more inflatable floats;
the one or more inflatable floats each including an air bladder;
the air bladder including a connection for inflation by a diver's air tank;
the one or more inflatable floats each affixed to a spike, the spike for attachment to a fish caught while diving;
wherein after the spike of an inflatable float is affixed to the fish, the inflatable float is inflated using the diver's air tank;
whereby the fish then floats to the surface.

15. The device of claim 14, wherein the air bladder of each inflatable float includes an over-inflation valve, the over-inflation valve configured to expel bursts of air out of the air bladder as each float rises to the surface.

16. The device of claim 14, wherein the one or more inflatable floats are removably attached to a diver.

17. The device of claim 14, wherein the one or more inflatable floats vary in size.

18. The device of claim 14, wherein the one or more inflatable floats include a reflective portion.
